(19) United States
(12) Patent Application Publication
(10) Pub. No.: US 2008/0152275 A1
(43) Pub. Date: Jun. 26, 2008

(54) VEHICLE WHEEL HUB BEARING UNIT

(75) Inventor: Shaowei WU, Xiangfan (CN)

Correspondence Address: MATTHIAS SCHOLL, 14781 MEMORIAL DRIVE, SUITE 1319, HOUSTON, TX, 77079, US

(73) Assignee: XIANGFAN NEW TORCH AUTO PARTS EQUIPMENT CO., LTD., Xiangfan (CN)

(21) Appl. No.: 11/617,755

(22) Filed: Dec. 29, 2006

(30) Foreign Application Priority Data
Dec. 21, 2006 (CN) 200620172486.8

(51) Int. Cl. F16C 13/02

(52) U.S. Cl. 384/544

(57) ABSTRACT

The present invention provides a vehicle wheel hub bearing unit with the purpose of solving the drawbacks of conventional wheel hub bearing units, such as their complicated structure, which causes difficult assembly, low hardness, strength, and running precision, and high noise and vibration. The vehicle wheel hub bearing unit of the present invention is comprises an outer flange, a small inner ring, a set of rolling elements, a retainer, an inner flange, a seal ring, a gear rim, an ABS wheel speed sensor, and a knurled bolt, wherein a pair of outer channels or races that are engageable with the rolling elements are formed on the outer flange. By utilizing the vehicle wheel hub bearing unit of the present invention, not only is the structure simplified, making the assembly convenient, but also the degree of integration and downsizing is improved. Moreover, the unit is free of servicing for its entire life.

### CROSS-REFERENCE TO RELATED APPLICATIONS

This application claims priority to the Chinese Patent Application No. 200620172486.8 filed Dec. 21, 2006, the contents of which are incorporated herein by reference.

### BACKGROUND OF THE INVENTION

1. Field of the Invention

This invention relates to a vehicle wheel hub bearing unit.

2. Description of the Related Art

Conventional vehicle wheel hub bearing units are assembled by forcibly fitting two sets of ball or roller bearings and an outer and inner ring into a space between the outer flange and the inner flange. However, since many components are involved during the assembly process, this conventional solution has a series of disadvantages: 1) The structure is complicated, making the assembly inconvenient. In particular, it is easy for rotational deformations to occur during the assembly process. 2) The hardness, strength, and running precision of the components are low, causing noise and vibration during operation to be high, thus negatively influencing the service life of the bearing unit.

### SUMMARY OF THE INVENTION

In view of the above-described disadvantages, it is an objective of the present invention to provide a vehicle wheel hub bearing unit that not only has a simple structure that makes the assembly convenient, but also has the features of high hardness, strength, and good precision.

To achieve the above objective, a vehicle wheel hub bearing unit of the present invention comprises an outer flange, a small inner ring, a set of rolling elements, a retainer, an inner flange, a seal ring, a gear rim, an ABS wheel speed sensor, and a knurled bolt, wherein a pair of outer channels or races that are engageable with the rolling elements are formed on the outer flange.

In certain embodiments of the present invention, an inner channel or race that is engageable with the rolling elements is formed on the inner flange.

In certain embodiments of the present invention, the surfaces of the outer channels or races have been treated using a high frequency quenching process.

In certain embodiments of the present invention, the outer channels or races and the contact surface between the outer flange and the seal ring have been treated using a synchronous grinding process.

In certain embodiments of the present invention, the surface of the inner channel or race, and the contact surface between the inner flange and the gear rim and the small inner ring have been treated using a high frequency quenching process.

In certain embodiments of the present invention, the inner channel or race, the contact surface between the inner flange and the seal ring, the contact surface between the inner flange and the small inner ring, the inner channel or race of the small inner ring, and the contact surface between the inner channel and the seal ring have been treated using a synchronous grinding process.

In accordance with the vehicle wheel hub bearing unit of the present invention, the outer ring and the inner ring in the original structures are eliminated; instead, the outer channels or races and the inner channel or race are formed directly on the outer flange and the inner flange respectively. Therefore, not only is the structure simplified, making its assembly convenient, but also the degree of integration and downsizing is improved. Moreover, the unit is free of servicing for its entire life. By applying high frequency quenching and synchronous grinding processes, the hardness, strength, and running precision of the components are increased; the deformation of the small inner ring during the assembly is improved obviously; in addition, noise and vibration during operation is reduced, and the service life is accordingly increased.

### BRIEF DESCRIPTION OF THE DRAWINGS

FIG. 1 is a structural view of a vehicle wheel hub bearing unit in accordance with a first embodiment of the present invention;

FIG. 2 is a structural view of a vehicle wheel hub bearing unit in accordance with a second embodiment of the present invention;

FIG. 3 is a structural view of a vehicle wheel hub bearing unit in accordance with a third embodiment of the present invention; and

FIG. 4 is a structural view of a vehicle wheel hub bearing unit in accordance with a fourth embodiment of the present invention.

The reference numbers for the various parts shown in the drawings are listed below, in which the outer flange corresponds to the number 1; the small inner ring—2 (inner ring—2A); rolling elements—3 (steel ball—3A, roller—3B); retainer—4; inner flange—5; seal ring—6; gear rim—7; ABS wheel speed sensor—8; knurled bolt—9; outer channel—10A; outer race—10B; inner channel—11A; and inner race—11B.

### DETAILED DESCRIPTION OF THE EMBODIMENTS

The vehicle wheel hub bearing unit according to the present invention will be described further hereinafter, referring to the related drawings.

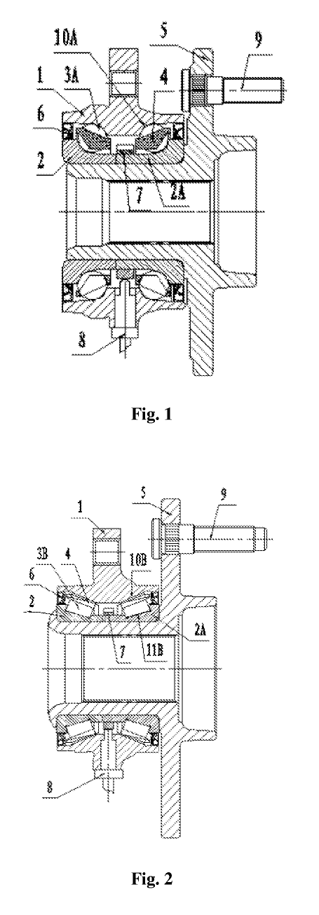

FIG. 1 illustrates a vehicle wheel hub bearing unit in accordance with a first embodiment of the present invention. A pair of outer channels 10A that are engaged with the rolling elements 3 are formed on the outer flange 1, wherein the surfaces of the two outer channels 10A have been treated using a high frequency quenching process; the two outer channels 10A and the contact surface between the outer flange 1 and the seal ring 6 have been treated using a synchronous grinding process; a plurality of steel balls is used as the rolling elements. The wheel hub bearing unit of the first embodiment is then realized by assembling the components.

FIG. 2 illustrates a vehicle wheel hub bearing unit in accordance with a second embodiment of the present invention. Differentiated from the wheel hub bearing unit of the first embodiment, a plurality of rollers 3B is used for the rolling elements 3, and correspondingly, the outer channels 10A are substituted by outer races 10B. All other processes and components in the second embodiment are the same as those in the first embodiment.

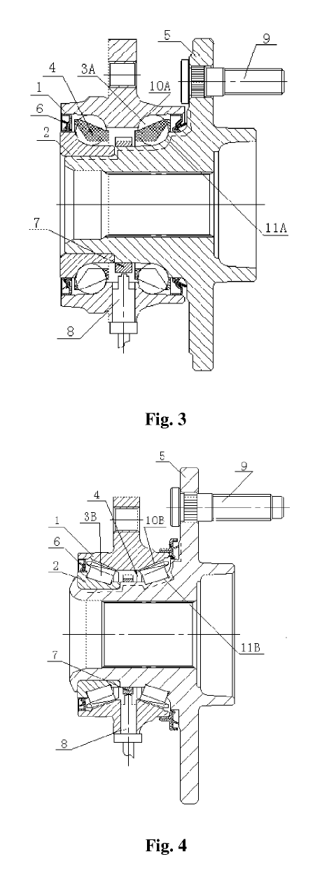

FIG. 3 illustrates a vehicle wheel hub bearing unit in accordance with a third embodiment of the present invention. A pair of outer channels 10A that are engaged with the rolling elements 3 are formed on the outer flange 1, an inner channel 11A that is engaged with the rolling elements 3 is formed on the inner flange 5, wherein the surfaces of the two outer channels 10A, the surface of the inner channel 11A, and the contact surfaces between the inner flange 5, the gear rim 7, and the seal ring 6 have been treated using a high frequency quenching process; the two outer channels 10A, the contact surface between the outer flange 1 and the seal ring 6, the inner flange 11A, the contact surface between the inner flange 5 and the seal ring 6, the contact surface between the inner flange 5 and the small inner ring 2, the inner channel of the small inner ring 2, and the contact surface between the small inner ring 2 and the seal ring 6 have all been treated using a synchronous grinding process; a plurality of steel balls 3A is used for the rolling elements 3. The wheel hub bearing unit of the first embodiment is then realized by assembling the components.

FIG. 4 illustrates a vehicle wheel hub bearing unit in accordance with a fourth embodiment of the present invention. Differentiated from the wheel hub bearing unit of the third embodiment, a plurality of rollers 3B is used for the rolling elements 3, and correspondingly, the outer channels 10A are substituted by outer races 10B, and the inner channel 11A is changed to an inner race 11B. All other components in the fourth embodiment are the same as those in the third embodiment.

While the invention has been described with respect to preferred embodiments, it will be clear to those skilled in the art that modifications and improvements may be made to the invention without departing from the spirit and scope of the invention. Therefore, the invention is not to be limited by the specific illustrative embodiments, but only by the scope of the appended claims.

What is claimed is:

1. A vehicle wheel hub bearing unit, comprising: an outer flange, a small inner ring, a set of rolling elements, a retainer, an inner flange, a seal ring, a gear rim, an ABS wheel speed sensor, a knurled bolt, and a pair of outer channels or outer races engageable with said rolling elements, wherein said pair of outer channels or outer races are disposed on said outer flange.

2. The vehicle wheel hub bearing unit of claim 1, comprising further an inner channel or inner race engageable with said rolling elements, wherein said inner channel or inner race is formed on said inner flange.

3. The vehicle wheel hub bearing unit of claim 1, wherein the surfaces of said outer channels or races have been treated using a high frequency quenching process.

4. The vehicle wheel hub bearing unit of claim 1, wherein said outer channels or races and the contact surface between the outer flange and the seal ring have been treated using a synchronous grinding process.

5. The vehicle wheel hub bearing unit of claim 2, wherein the surface of said inner channel or race, and the contact surface between the inner flange and the gear rim and the small inner ring have been treated using a high frequency quenching process.

6. The vehicle wheel hub bearing unit of claim 2, wherein the inner channel or race, the contact surface between the inner flange and the seal ring, the contact surface between the inner flange and the small inner ring, the inner channel or race of the small inner ring, and the contact surface between the inner channel and the seal ring have been treated using a synchronous grinding process.
